(19) United States
(12) Patent Application Publication
(10) Pub. No.: US 2014/0041292 A1
(43) Pub. Date: Feb. 13, 2014

(54) VINE TRELLISING COMBINED SHADE AND BIRD CONTROL SYSTEM

(71) Applicant: Bryan Babcock, Santa Barbara, CA (US)

(72) Inventor: Bryan Babcock, Santa Barbara, CA (US)

(21) Appl. No.: 13/952,239

(22) Filed: Jul. 26, 2013

Related U.S. Application Data
(63) Continuation-in-part of application No. 13/572,296, filed on Aug. 10, 2012.

(51) Int. Cl. A01G 17/04

(52) U.S. Cl. CPC A01G 17/04
USPC 47/31; 47/20.1; 47/32.3

(57) ABSTRACT

A vine support system includes a multiple vine stakes, each vine stake adjacent and supporting a vine trunk. A plurality of shade hotels are removably mounted to the vine stakes, each shade hotel incorporating a securing bail. A shade element is removably supported by each shade hotel and restrained by the securing bail.

### REFERENCE TO RELATED APPLICATIONS

This application is a continuation in part of application Ser. No. 13/572,296 filed on Aug. 10, 2012 entitled TRELLISING SYSTEM AND VITICULTURE METHOD having a common assignee with the present application, the disclosure of which is incorporated herein by reference.

### BACKGROUND

1. Field

This invention relates generally to the field of viticulture, in particular to the design and manufacture of grapevine trellis systems and to methods for grapevine canopy and crop management, and more particularly, to a trellis system having a novel structure for supporting shade canopies with or without combined bird netting.

2. Description of the Related Art

Vineyard management for both wine and table grapes has varied over many generations of farmers. With modern viticulture techniques consistency in crop yields and character particularly in wine grapes is being established. Such consistency is imperative for creation of high quality wines. European and American viticulturalists have developed several predominant techniques for managing wine producing vines. FIG. 1A shows a prior art trellising approach for grape vines (Vertical Shoot Positioning “VSP”) with support wires 10 extending between posts 12 and with cordons or fruiting canes 14 extending from the vine's trunks 16, supported horizontally by a lower wire 14 approximately 24 inches above ground, Trunks 16 are pruned to maintain this height. If cordons are established they are maintained yearly in this position 14. If fruiting canes are established, they are replaced by new canes yearly in this position 14. A series of upper wires 18 are then used to vertically support the shoots 20 extending from the cordons (or fruiting canes) with leaves forming the canopy 22 of the vine above the cordons as shown in greater detail in FIG. 1B.

This requires that the yearly growth of shoots, grapes and leaves be supported above the cordons or new canes which is a basically unstable position relying solely on the support of the trellis wires both vertically and laterally.

This technique does not provide optimum conditions for machine harvesting, nor does it proved optimum spring frost protection, and requires significant “structure” in the form of support wires and other devices to support the crop above the cordons, along with the requirement of significant labor in order to place the vines each year up into this structure, as well the significant labor that is necessary to prune the vines out of the structure at the end of each season.

Shading of vines during high temperature seasons is also problematic with existing viticultural structures. Fixed shading structures provide excessive sun blockage during important growth periods for the vines and no viable approach for temporary shading is available.

It is therefore desirable to provide a novel infrastructure that supports the vines in a way that reduces the currently employed support structures as well as the costs required to operate them, with availability of shading and bird control support structures that are easily implemented when desired and immediately removable for efficiency of machine harvesting.

### SUMMARY

The embodiments disclosed herein overcome the shortcomings of the prior art by providing a vine support system which includes multiple vine stakes, each vine stake adjacent and supporting a vine trunk. A plurality of shade hotels are removably mounted to the vine stakes, each shade hotel incorporating a securing bail. A shade element is removably supported by each shade hotel and restrained by the securing bail.

### BRIEF DESCRIPTION OF THE DRAWINGS

These and other features and advantages of the present invention will be better understood by reference to the following detailed description of exemplary embodiments when considered in connection with the accompanying drawings wherein:

FIGS. 1A and 1B are examples of a prior art trellising approach used commonly in California viticulture;

FIG. 2 is an isometric view of the support post elements for the inventive embodiment;

FIG. 3A is an isometric view of the pedestal assembly;

FIG. 3B is an isometric view of the cane pedestal with the hub of the pedestal assembly received over an exemplary positioning shaft with vertical adjustment pin;

FIG. 3C is a front view of the vine stakes and cane pedestal assemblies supporting canes extending from a trunk;

FIG. 3D is an isometric view of an alternative embodiment of the cane pedestal;

FIG. 4A is an isometric view of the canopy shade support tree (hotel);

FIG. 4B is an isometric view of the hotel with an asymmetrical horizontal support;

FIG. 4C is an isometric view of an alternative embodiment of the hotel with even vertical supports;

FIG. 4D is an isometric view of an embodiment of the hotel to be employed on vine stakes;

FIG. 4E is an isometric view of an embodiment of the hotel to be employed with a cane pedestal as shown in FIG. 3D;

FIG. 5 is a pictorial view of a vineyard orientation adapted to maximize the benefits of the trellising system of the embodiments of FIGS. 2-4E;

FIG. 6A is an isometric view an alternative hotel embodiment which provides support for a shade structure;

FIG. 6B is a front view of the shade hotel embodiment of FIG. 6A;

FIG. 7 is a detailed isometric view of the shade hotel with the securing bail open;

FIG. 8A is an isometric view of the shade hotel as attached to a vine stake in a first configuration;

FIG. 8B is an isometric view of the shade hotel with a central boss to be concentrically attached to the vine stake or a intermediate positioning shafts;

FIG. 9A is a front view of the shade hotel with a shade element inserted and retained by the bail;

FIG. 9B is an isometric view of the shade element as supported by the shade hotel;

FIG. 10A is a front view of the shade hotel with a shade element and integrated bird net drape;

FIG. 10B is a detailed front view of the shade hotel with a shade element and integrated bird net drape;

FIG. 10C is an isometric view of the shade hotel with a shade element and integrated bird net drape;

FIG. 11 is a pictorial view showing a series of vine stakes with shade hotels with a shade element supported in the shade hotels (intermediate positioning shafts, pedestals and vine supports are not shown); and,

FIG. 12 is a top view of an exemplary gradient shade element.

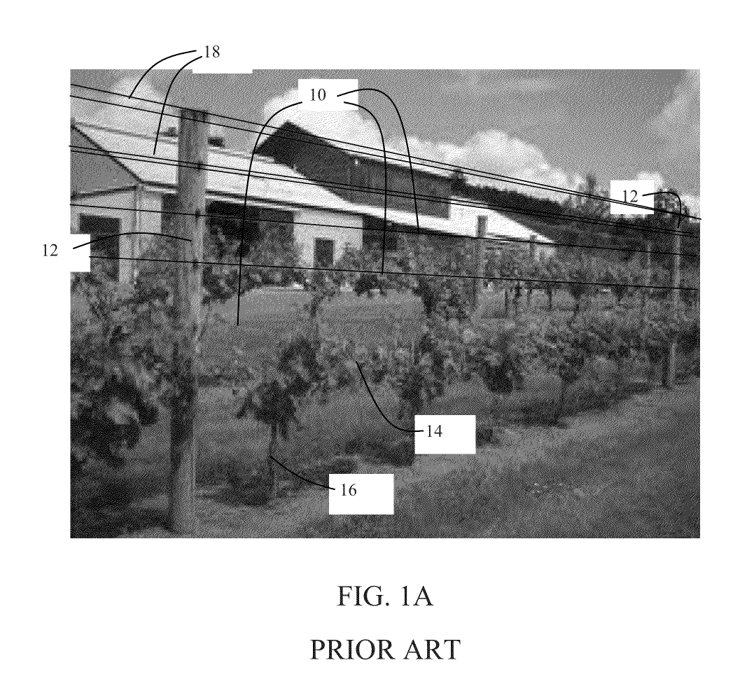

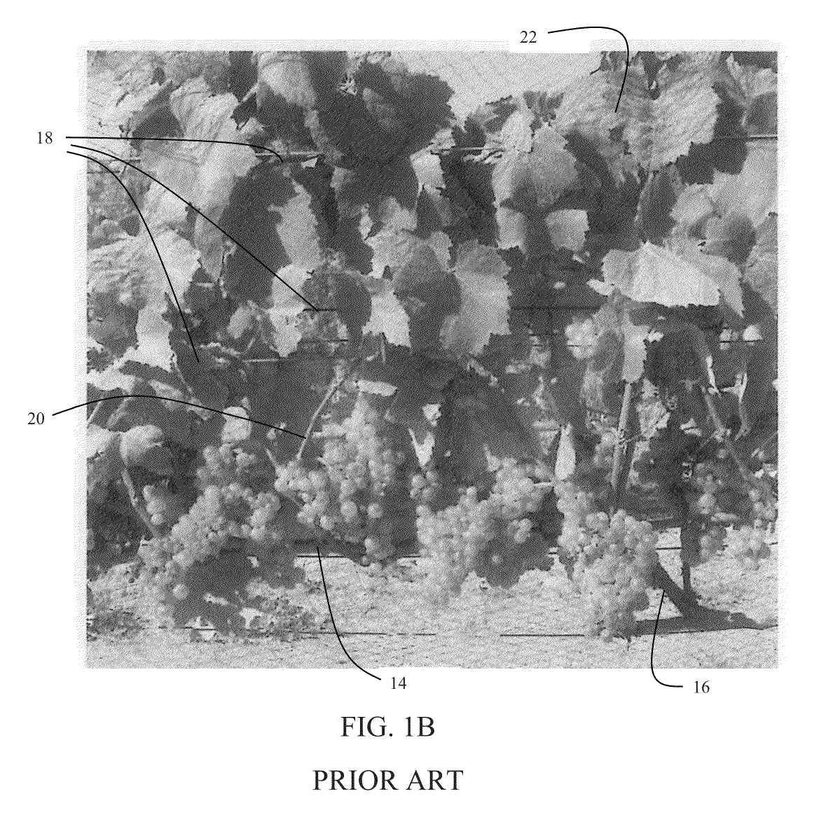

### DETAILED DESCRIPTION

Embodiments shown in the drawings and described herein provide a viticultural method and system for alternative positioning of canes in individual grape vines at a higher level than normal prior art practice, nominally 48 to 60 inches with the trunk extending to that height. The canes are then horizontally positioned outward from the trunk held by “cane pedestals” which support the canes vertically but allow rotation or pronation of the canes within the supporting suspension arms. At this higher level, as new shoot growth appears from the canes, instead of being supported above the cane, the canes pronate in the cane pedestals to allow the new growth to hang downward, a much more natural positioning, which allows the weight of the fruit to be borne by the cane as opposed to being suspended in support wires. Positioning of the vineyard rows relative to a prevailing breeze additionally allows the force of the wind against the shoots and leaves to enhance the pronation of the canes, thereby delivering shoots and leaves to a hanging position.

For descriptive purposes herein, early in a season, new growth is typically referred to as a “shoot”. A “cane” typically describes a mature shoot, one that has undergone a significant amount of lignification and has become pliable and/or woody. Canes produced in any given season are considered to be “first year canes”. Canes held over into a second year to be employed as the source for the subsequent year's growth are considered to be “second year wood, fruiting canes, or fruiting wood”. During the winter subsequent to a growing season, the first year canes desired for the next year's growth are retained, as will be described subsequently, and the present system may be defined as cane pruned. The retained canes are laid out horizontally and at each bud on the canes, a new shoot emerges the next spring. On the new shoots resides the new crop.

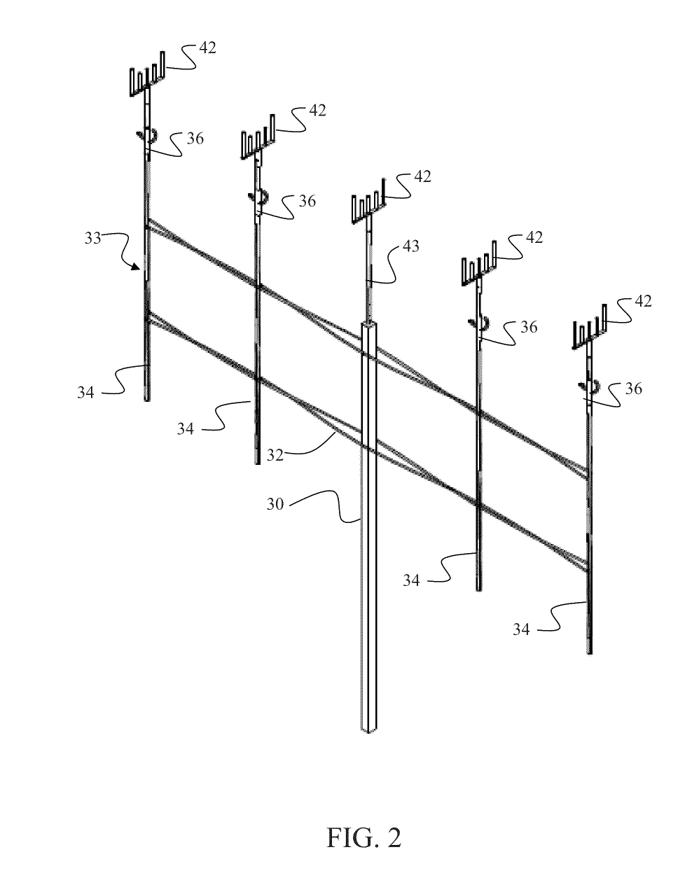

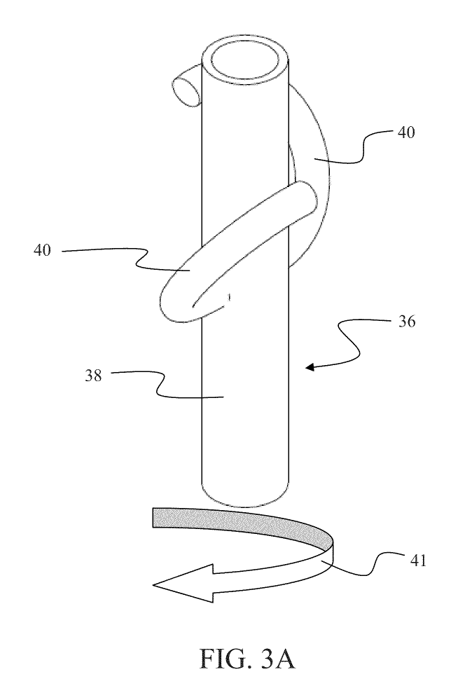

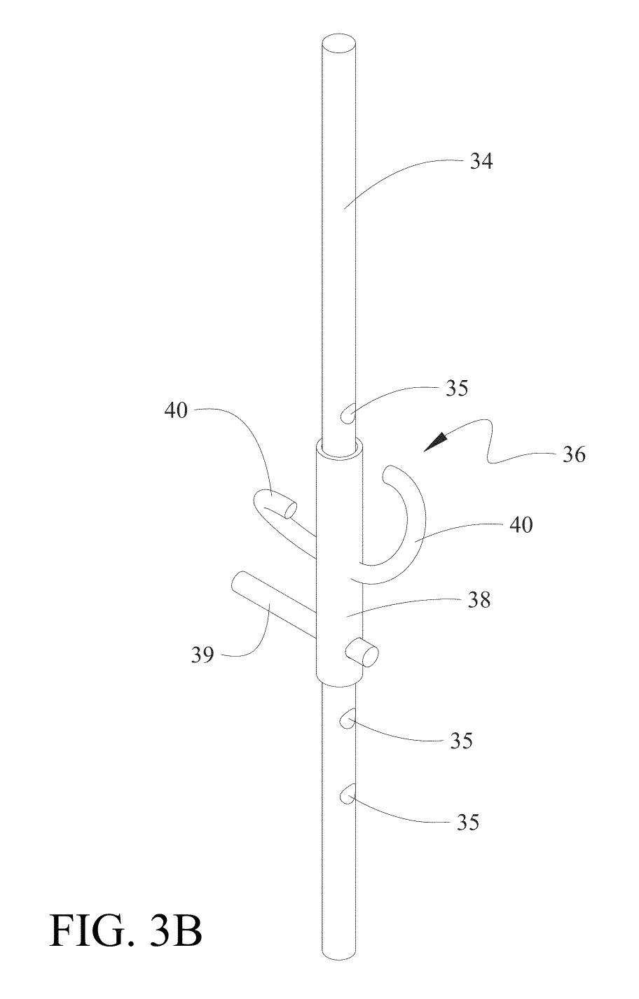

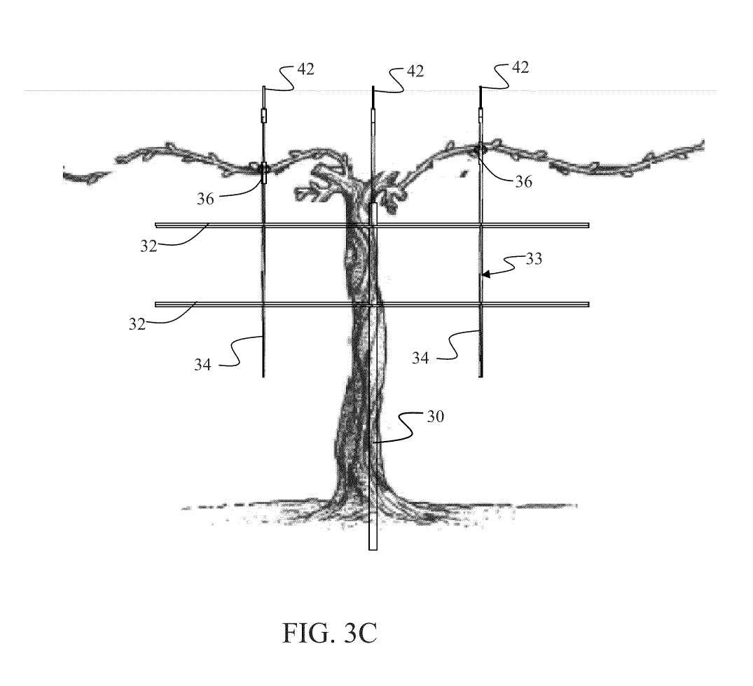

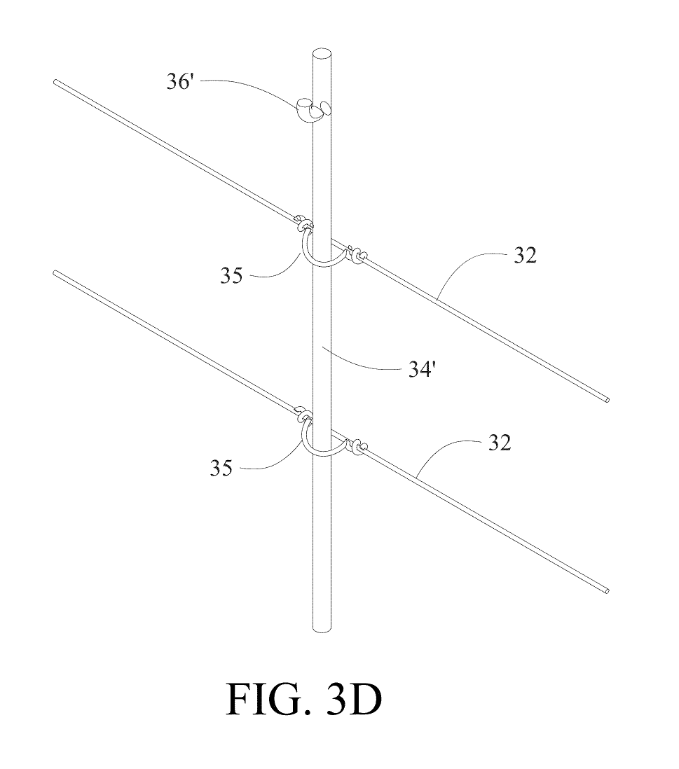

As shown in FIG. 2 the embodiment for the infrastructure of the current invention employs vine stakes 30 placed at or near the trunk of the vines with support wire 32 extending laterally. In a first embodiment, cane pedestals 33 are supported by positioning shafts 34 suspended on the support wire which engage a helical pedestal assembly 36 shown in detail in FIG. 3A having a central attachment hub 38 and suspension arms 40 extending arcuately from the hub. The helical pedestal assembly may be rotated about the positioning shaft as shown by arrow 41 in FIG. 3A to free or engage the fruiting canes from the arcuate suspension arms 40 to provide pedestular support for the canes. In an exemplary embodiment, the suspension arms are helical in shape to enhance the engagement/disengagement of the canes by rotating the hub on the positioning shaft. The suspension arms have an effective diameter to sufficiently hold the canes loosely but allow the pronation of the canes without constraint. The hub 38 may additionally be adjustable vertically on the positioning shaft 34 to adjust the horizontal height of the fruiting canes as shown in FIG. 3B. Locking of the hub 38 at a desired height may be accomplished by pins 39 inserted through spaced holes 35 in the positioning shafts 34. The helical pedestal assembly 36 supports retained canes on the arcuate suspension arms 40 as shown in FIG. 3C.

An alternative embodiment of the cane pedestal 33 is shown in FIG. 3D wherein the positioning shaft 34′ is retained on the support wire 32 with a drag loop 35. This allows the positioning shaft 34′ to be directly adjusted vertically without a separate hub and at least one suspension arm 36′ extends directly from the positioning shaft 34′. The drag loop 35 additionally allows the positioning shaft 34′ to be rotated thereby rotating the suspension arm 36′, if desired, to engage or disengage the canes.

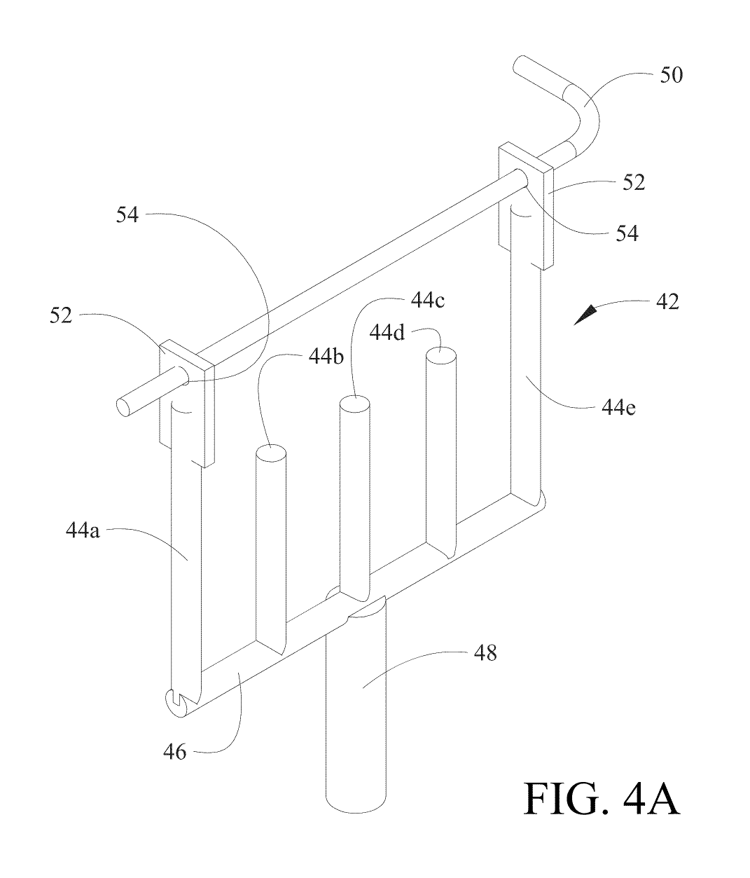

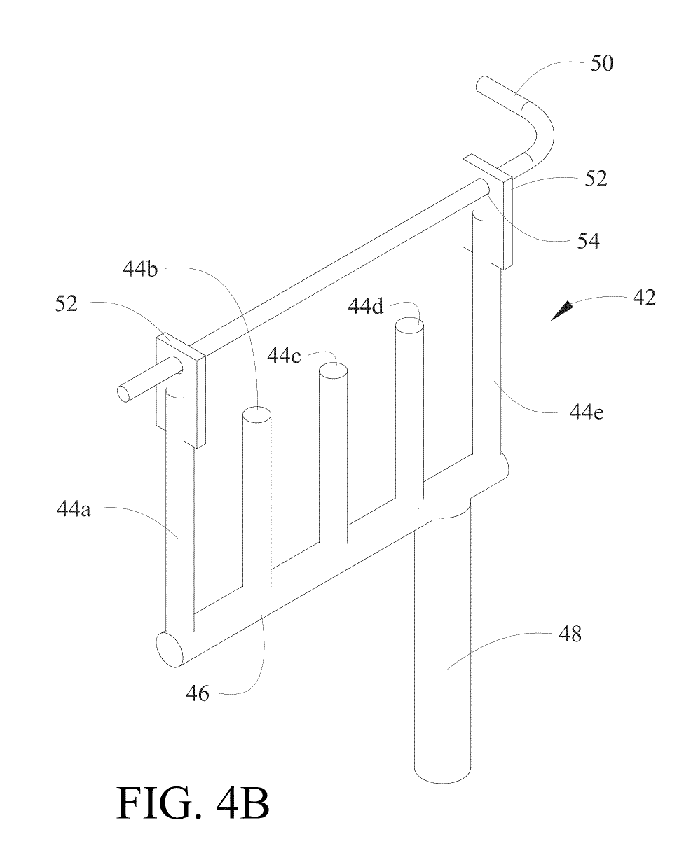

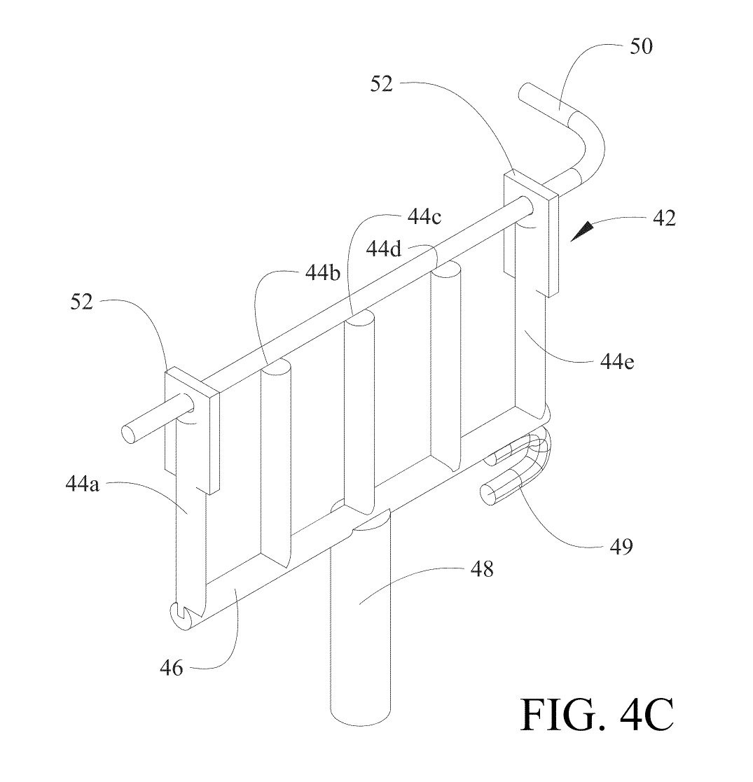

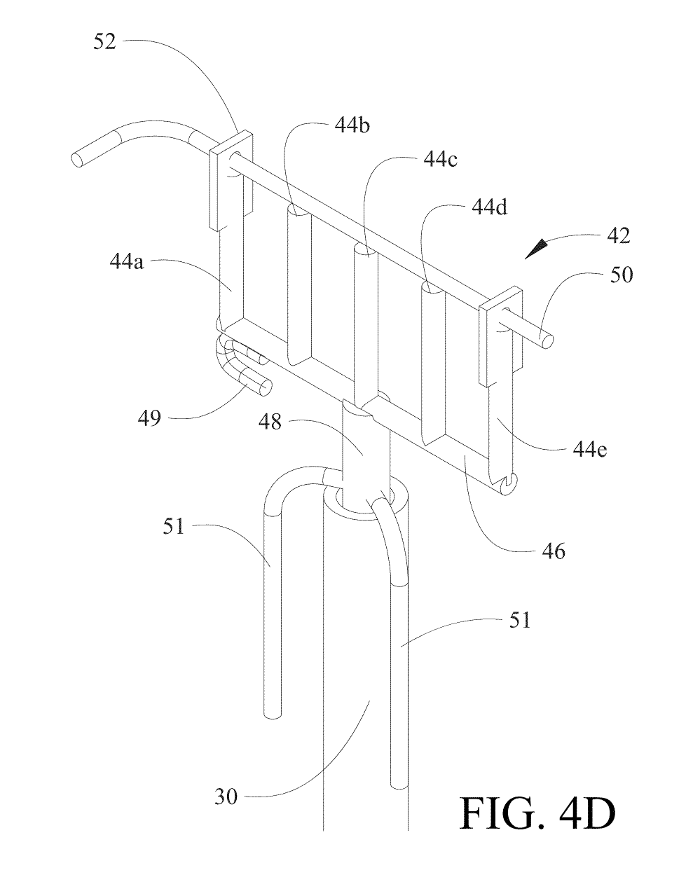

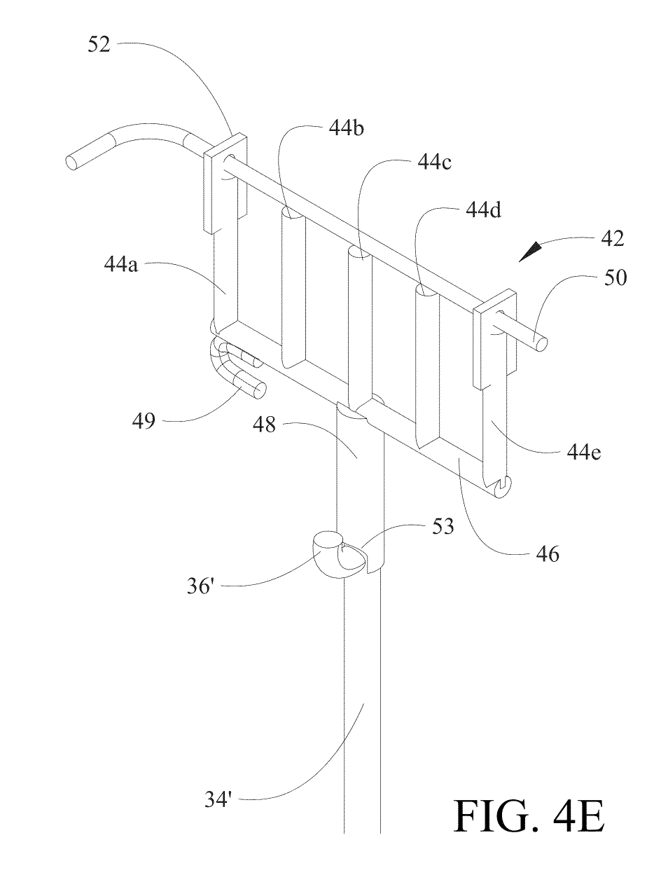

Additionally, in the middle of the growing season, a support tree or hotel 42, as shown in detail in FIG. 4A, is positioned on the crown of each positioning shaft 34 and a crown rod 43 extending from the vine stakes 30 to support shoots and leaves in a longitudinal shade canopy, referred to as the “shade line”, the source of which is a collection of green growing shoots which emanate every year from the trunks of the vines. The hotel includes vertical restraints 44a-44e extending from a horizontal support 46 which is attached to the positioning shafts with a cylindrical boss 48 having a bore to receive the crown of the positioning shaft. Shoots may be placed between the vertical restraints for horizontal separation and supported by horizontal support 46 to create a shade line for the fruit zone extending below the canes supported on the pedestal supports. A retainer 50 is received in tabs 52 located at the tops of the outboard vertical restraints 44a and 44e to constrain the threaded shoots in the hotel. For the embodiment shown, the tabs incorporate apertures 54 to receive the retainer 50. By slight angular offset of tabs 52, the retainer may be frictionally secured within the apertures. Sufficient flexibility of the tabs allows deformation for substantial alignment of the apertures for insertion and removal of the retainer 50. In alternative embodiments, flexible ties or other securing elements may be employed to extend from the outboard vertical restraints to restrain the shade canopy shoots. As will be described in greater detail subsequently, the hotel may employ an asymmetrical horizontal support as show in FIG. 4B for offset shading of the vines. Additionally, the vertical restraints may extend evenly from the horizontal support as shown in FIG. 4C or may have varying stepped heights. A “C” bracket 49 may be attached to the horizontal support 46 which allows the hotel to be suspended from a support wire when not in use.

For hotels employed on the vine stakes 30, as an alternative to a crown rod 43, the boss 48 may be concentrically received within the vine stake and supported from the top of the stake with one or more arms 51 as shown in FIG. 4D. Similarly, for implementations of the pedestal assembly as shown and described with respect to FIG. 3D, the boss 48 of the hotel may include a slot 53 which is received over the suspension arm 36′ to prevent rotation of the boss and hotel on the crown of the positioning shaft 34′ as shown in FIG. 4E.

The support wire 32 suspends the positioning shafts 34 from below. No wires are present in the zone of the fruiting canes or in the zone of the crop enhancing the fruiting canes' ability to pronate, thereby releasing most of the vine's new shoots to easily grow, with gravity, in a downward direction. With less congestion in the fruiting zone, and with the crop in a more shakable position higher off the ground, mechanical harvesting is also enhanced. Additionally, the ability to remove the hotels 42 on and off of the support positioning shafts 34 and crown rods 43 provides unhindered growth of the vine's shoots resulting in the subsequent ease of overall canopy placement, the creation of shade lines, and a heightened speed of pruning.

To establish vines in the support system as described for the embodiments above, vine trunks are allowed to grow to approximately 48 to 60 inches. Selected fruiting canes are horizontally entrained in the suspension arms 40 of the pedestal assembly 36 which is the pronating portion of the canes, from opposite sides of adjacent trunks. Use of two opposing support arms 40 on the rotatable hub 38 for releasable support of the canes as shown in the drawings allows separate lateral positioning of the opposing canes; however, a single support arm may be employed in alternative embodiments with rotation of the hub freeing both opposing canes from the support arm. As previously described, rotation of the pedestal assembly 36 allows flexibility to engage or disengage the canes. As the fruit bearing shoots emerge from the canes, they gradually begin to be pushed downward by virtue of their increasing mass and by the encouragement of the pronation of the canes within the cane pedestals. Separate from this aspect of the vine's development, other shoots can be entrained longitudinally into the hotels from the vine's trunks to create a shade line with leaves above the canes and crop zone. Vertical adjustability of the rotatable hubs 38 on the positioning shafts 34 (or directly with drag loop supported positioning shafts 34′) as previously described allows flexibility in creating the desired amount of separation between the crop zone, and the shade line.

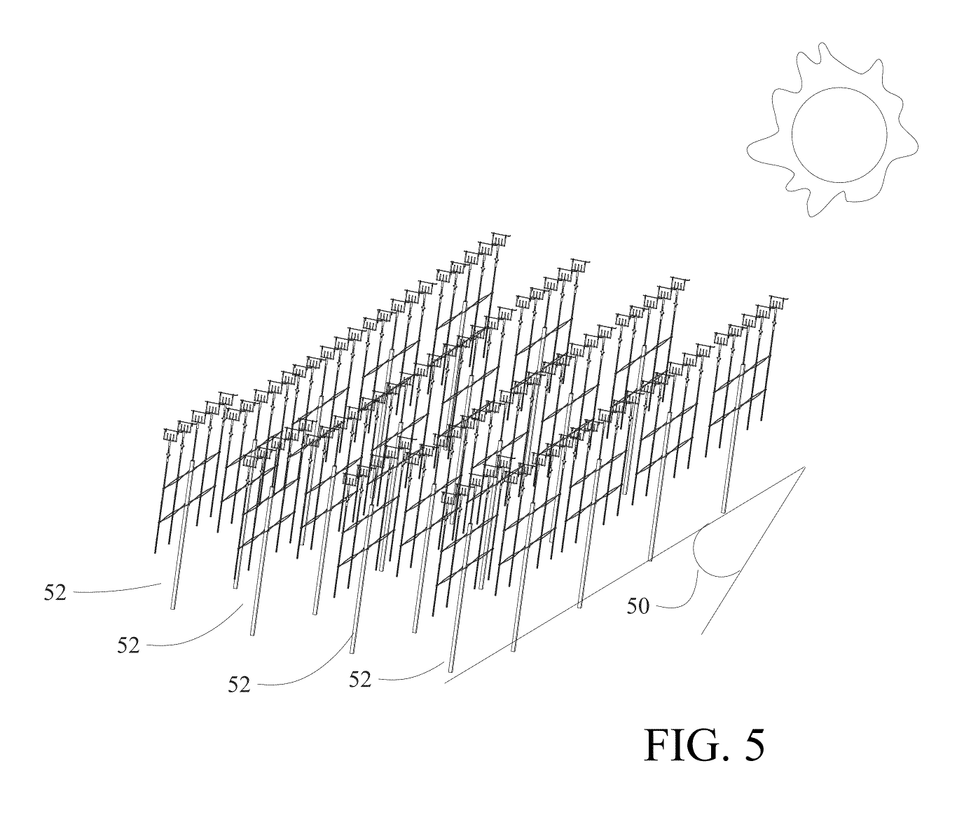

Employing the trellising system as described, vineyard rows may be positioned angularly with respect to solar transit to allow the shade canopy created by the hotels to shade the remainder of the vines during the hottest portions of the day. As shown in FIG. 5, a predetermined angle 50 of vine rows 52 may be established for layout of the vineyard. Additionally or alternatively, the hotels may be asymmetrical with one side of the horizontal support 46 extending further off centerline for greater shade with the sun angle on one side of the vineyard rows during the hotter part of the day. Overall width of the hotel horizontal support for shading is determined to compensate for the particular requirements of the grape varietal in the vineyard. For instance, Pinot Noir grapes and similar varietals may employ a narrower width hotel while Chardonnay or similar varietals would employ a wider hotel for greater shade over or longer portion of the day.

In employing the vine support system as described in the embodiments above, vine rows are oriented for alignment of rows with sun angle at the highest solar exposure for scorching to allow the hotel with entrained shoots and leaves to shade the crop zone hanging from the pedestularly supported canes. As an example for a vineyard near Lompoc, Calif. in the Santa Rita Hills viticultural area, orientation of vine rows at 210 deg (30 degrees west of south) provides optimum shading. As previously described, the hotel may also be asymmetrical with the horizontal support extending a greater distance on one side than the other to promote shading in vineyard rows which are not directly oriented with the maximum sun exposure angle. This may occur where orientation of the rows for substantially perpendicularity to the prevailing breeze for enhanced pronation of the canes may result in a different row angle than the maximum sun exposure angle. Additionally, such asymmetry may be employed with the addition of the support embodiments disclosed herein to vines in existing vineyard rows which may be oriented without respect to sun angle.

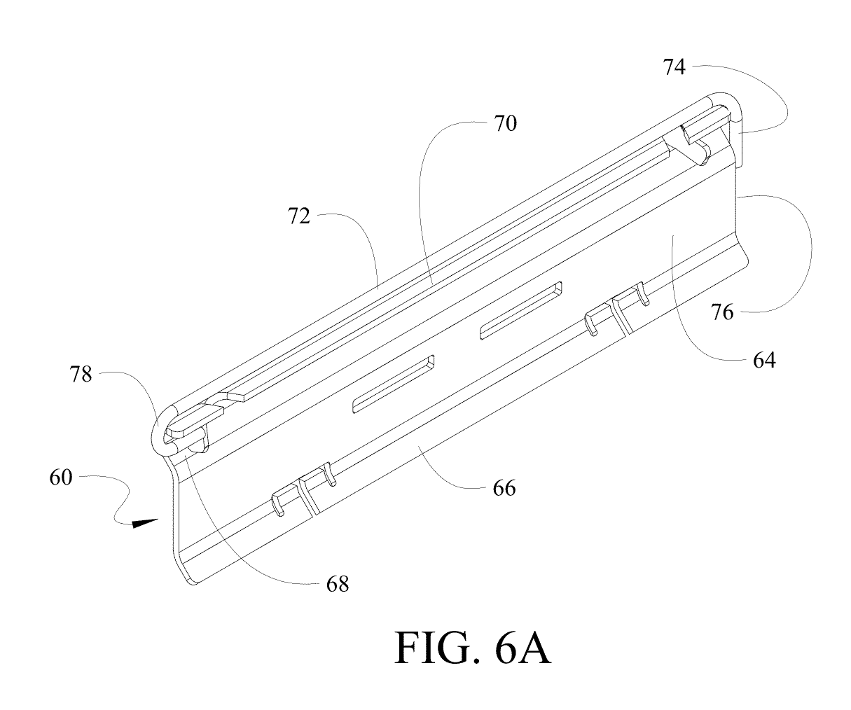

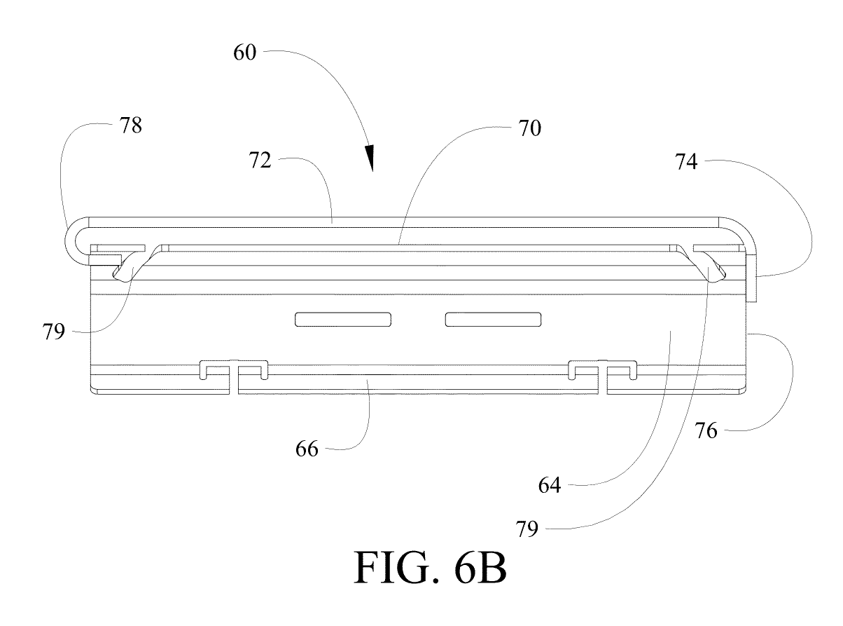

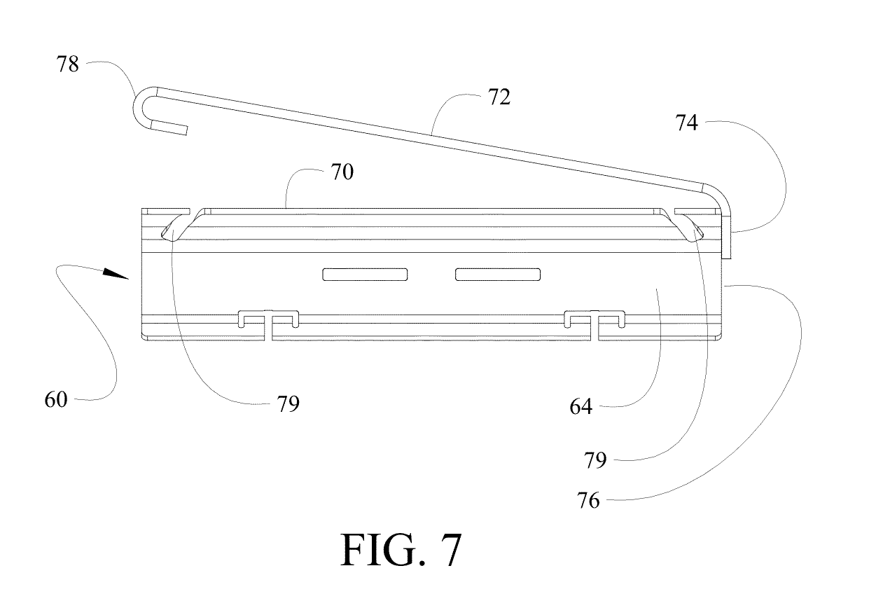

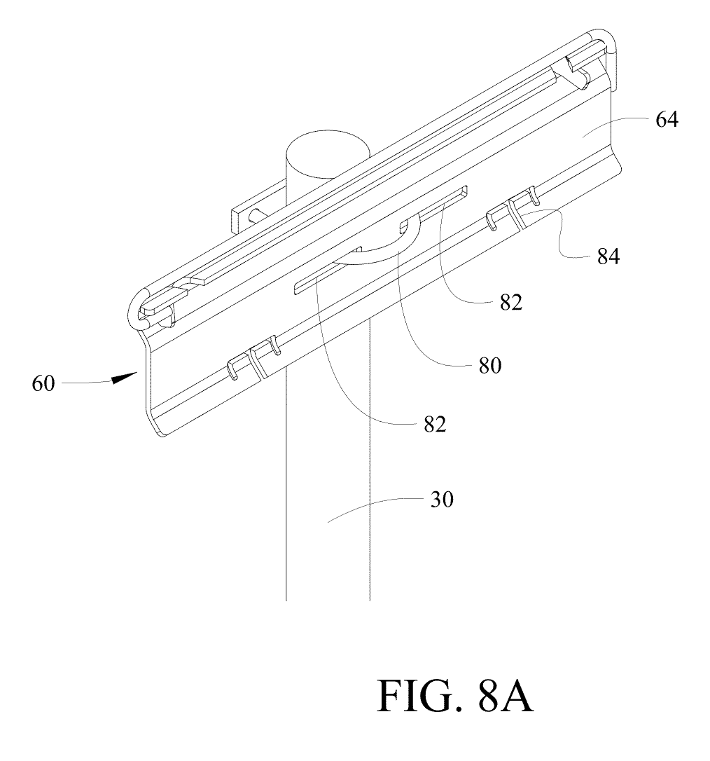

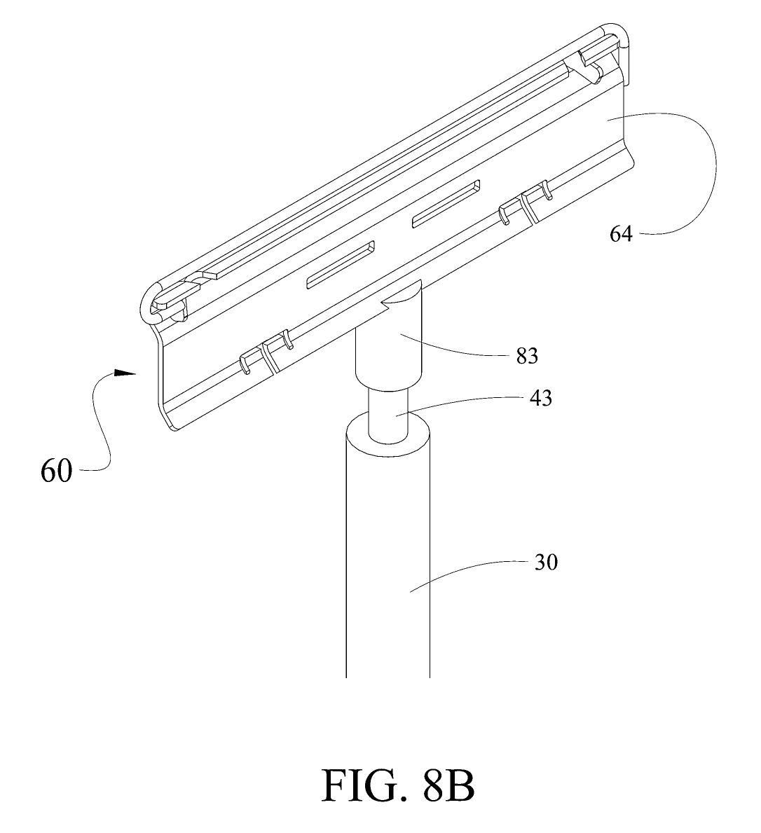

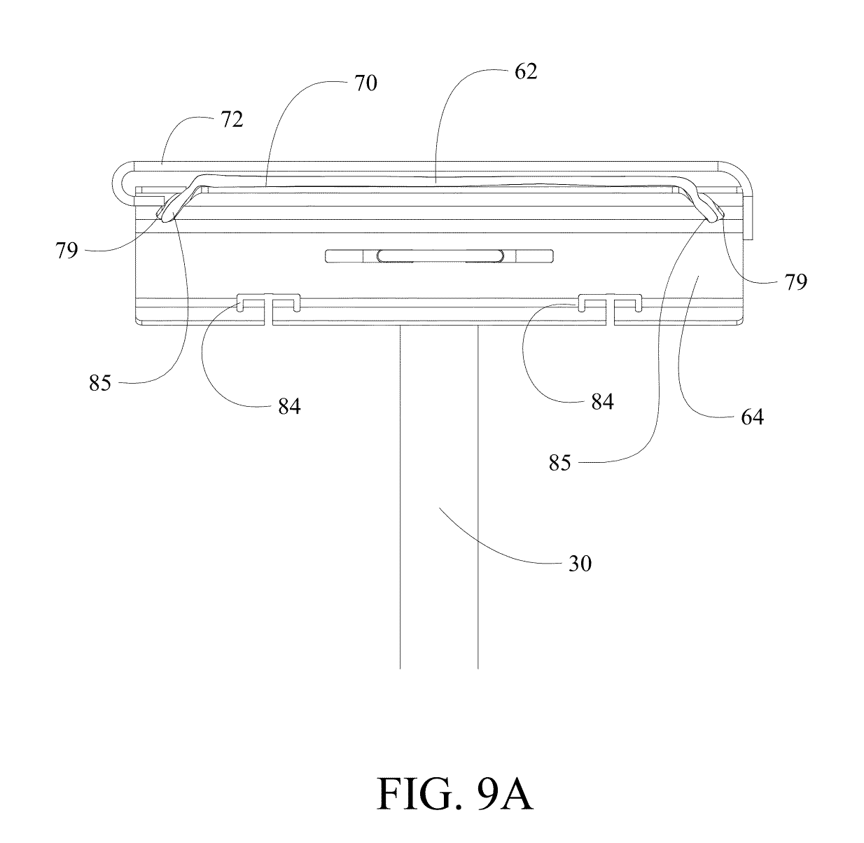

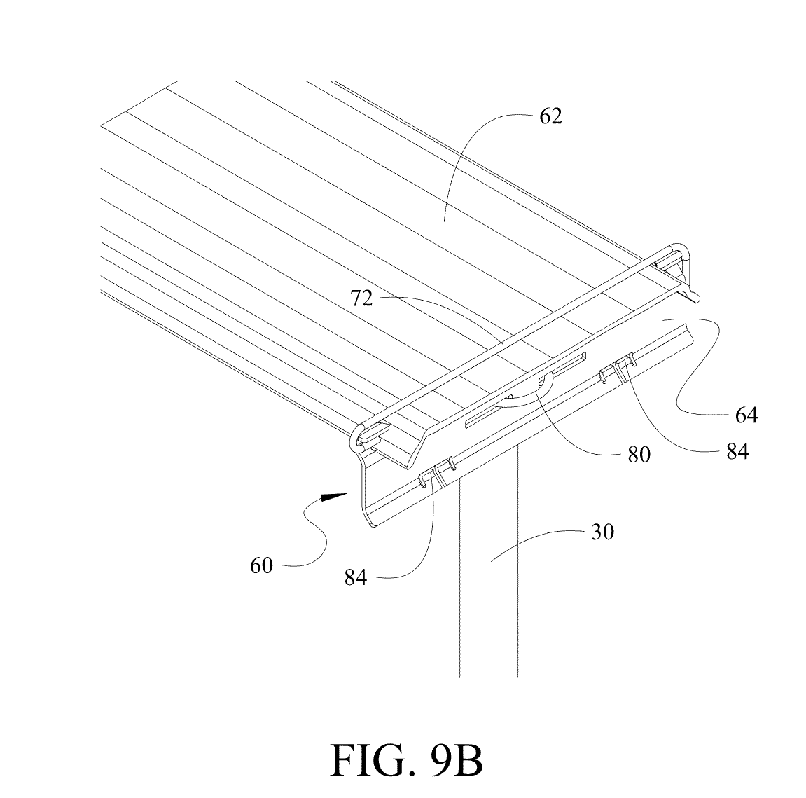

As an alternative to employing shoots and leaves as a shade canopy supported in a hotel, an alternative shade hotel 60 shown in FIGS. 6A, 6B and 7 may be employed to support a shade element 62 (described with respect to FIGS. 9A and 9B below). The shade hotel 60 employs a laterally extending plate 64 to be positioned on vine stakes 30 (shown and described with respect to FIGS. 8A and 8B below). While described herein for use on the vine stakes, the shade hotels may also be employed on the positioning shafts as previously described for the hotels of FIGS. 4A-4C. For the embodiment of the alternative shade hotel 60 shown, the plate 64 employs bent edge portions 66, 68 at the bottom and top, and the folded top flange 70 to enhanced rigidity allowing use of thinner gage materials if desired. A securing bail 72 extends across the top of the top flange 70 to secure the shade element. For the embodiment shown, the bail 72 is a resilient bar or tube attached at a base 74 to a first end 76 of the plate and bent to extend across the flange terminating in a bent hook 78 which is engaged under the top flange. As shown in FIGS. 6A and 7, the bail is resilient for the hook 78 to be released from the top flange 70 for insertion and removal of the shade element. Angle slots 79 are present in the top flange 70 and top edge portion 68 of the plate 64 to engage a shade element as will be described in greater detail subsequently.

As seen in FIGS. 8A and 8B, the shade hotel 60 may be attached to a vine stake 30 using a U-bolt 80 extending through slots 82 in the face of the plate 64. Other embodiments may employ a boss 83 extending from the bottom of the plate or similar structure to be received within or over the vine stake in concentric engagement such as the crown rods 43 or the crowns of support shafts 30 as previously described. The shade hotel 60 may additionally include T-slots 84 to engage lateral wires for support of shoots should it become desirable to create a shade line using shoots emanating from the trunks of the vines.

A shade element 62 is supported on the top flange 70 and secured with the bail 72 as shown in FIGS. 9A and 9B. Lateral edges 84 of the shade element may be received in the angle slots 79 to assist in securing the shade element to the shade hotel, adding local structural rigidity to the web of the shade element by creating a non-planar or angled edge portion. Alternatively, the lateral edges may be extended to the lateral boundary of the top flange and engaged by the curved ends of the bail 72. While a full width shade element is shown in the drawings, narrower shade elements may also be supported by the shade hotel and restrained by the bail 72. The narrower shade elements may be centered or offset for symmetrical or asymmetrical shading of the vines.

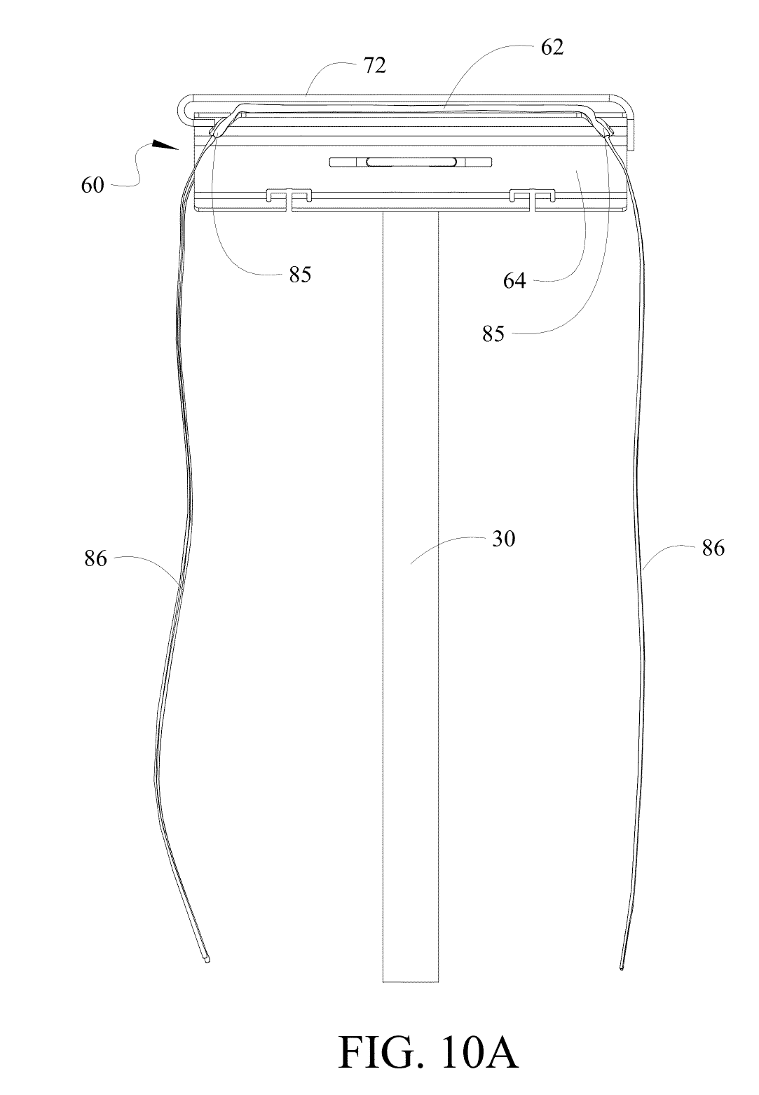

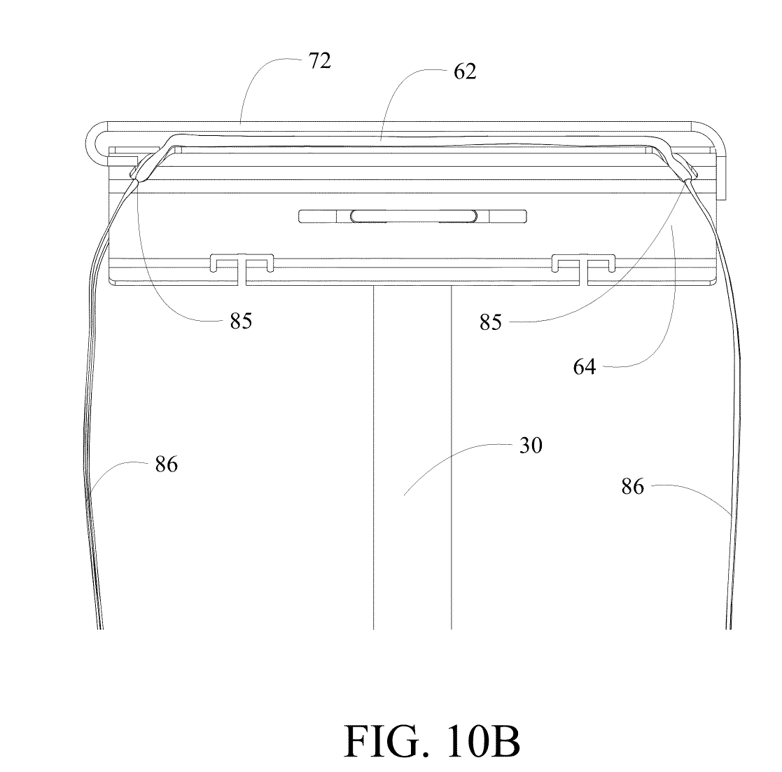

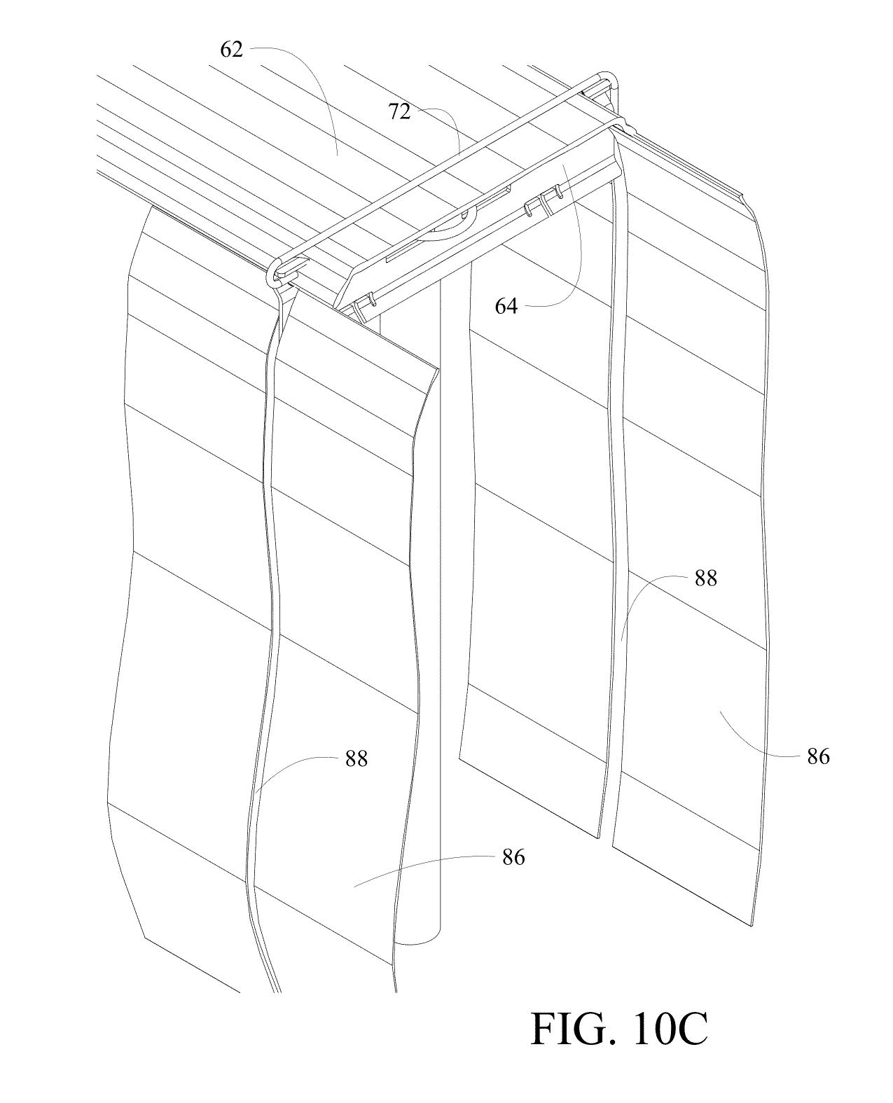

Additionally, net sides 86 may extend downward from the lateral edges 85 of the shade element as shown in FIGS. 10A, 10B and 10C. The net sides 86 may be integral to the shade element 62 with secure attachment by stitching or may be woven directly with the shade element employing a less dense weave providing an open net as opposed to a more densely woven shade cloth. The net sides may alternatively be removably attached using lacing or hook and loop fasteners. The net sides 86 are slit with vertical openings 88 through which the lateral ends of the hotel 60 may be received as seen in FIG. 10C. While shown as a full vertical opening from top to bottom, a partial slot sized to receive the hotel ends may be employed on removable net sides which may be attached after the shade element is mounted in the shade hotel. The net sides 86 drape over vines, canes and shoots enclosing the leaf canopy and fruit carried by the vines for protection from birds. The side nets may be of sufficient length to be gathered under the vines or drape to the ground.

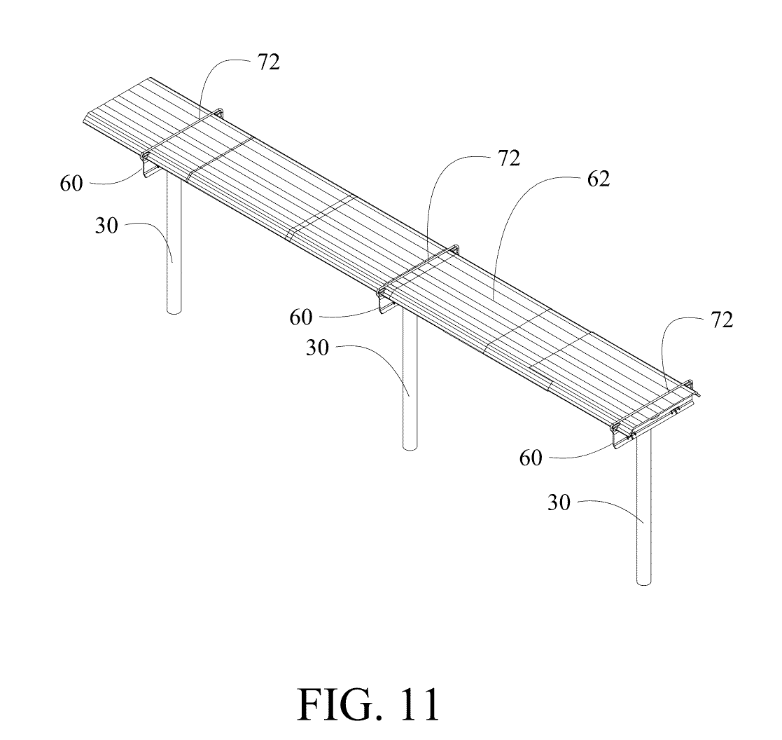

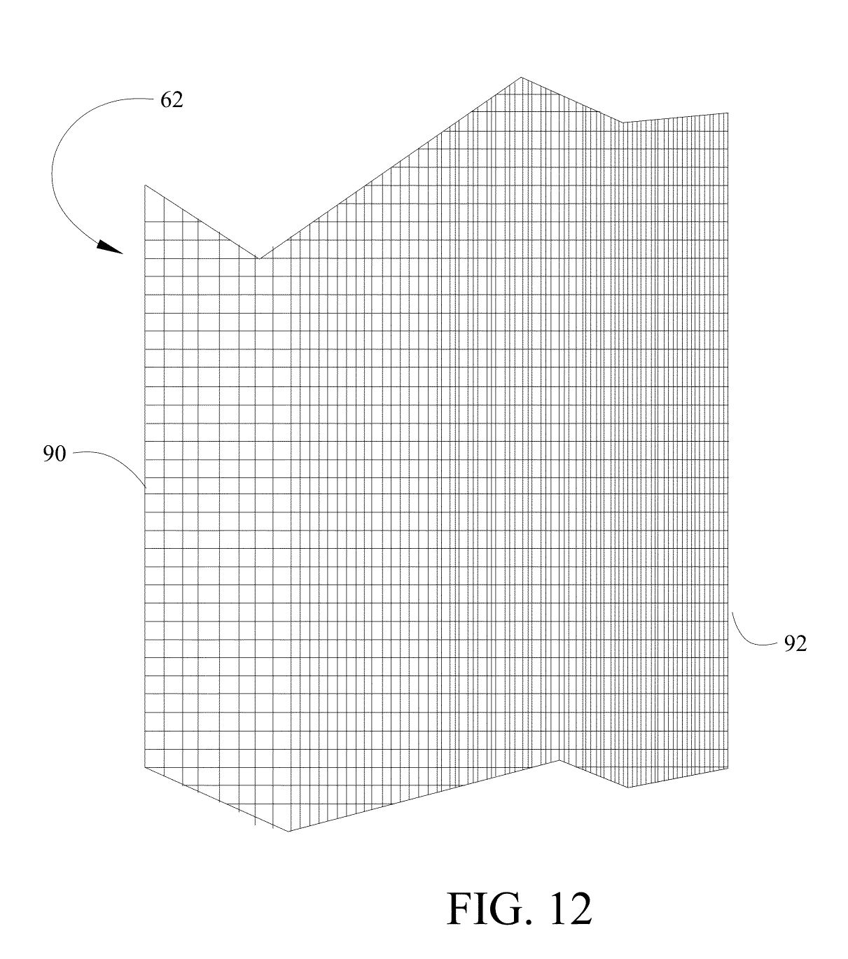

As shown in FIG. 11, a single shade element 62 may extend along the length of a row of vine stakes. The shade element may employ a flexible fabric which may be unrolled over the shade hotels 60 and secured by the bails 72 at each hotel. Integral net sides may then be deployed and secured or separate net sides attached to the lateral edges of the shade element as previously described. Woven shade fabrics such as those produced by TenCate, P.C. Stamstraat 19, P.O. Box 8, 7440 AA Nijverdal, The Netherlands, may be employed as the shade element. Varying of density of the weave from one lateral edge 90 to the other lateral edge 92 as shown in FIG. 12 may be employed for asymmetrical shading; for example in a north south oriented vine row a denser weave on the western portion of the shade element may provide additional afternoon sun protection for the vines. As previously described, the rows of vine stakes may be oriented to provide maximum shade by the shade element at a maximum solar exposure angle.

Having now described various embodiments of the invention in detail as required by the patent statutes, those skilled in the art will recognize modifications and substitutions to the specific embodiments disclosed herein. Such modifications are within the scope and intent of the present invention as defined in the following claims.

What is claimed is:

1. A vine support system comprising:
a plurality of vine stakes, each vine stake proximate a vine trunk;
a plurality of shade hotels removably mounted to the vine stakes, each shade hotel incorporating a securing bail; and,
a shade element removably supported by each shade hotel and restrained by the securing bail.

2. The vine support system as defined in claim 1 wherein each shade hotel incorporate a plate removably securable to the vine stake.

3. The vine support system as defined in claim 2 wherein the plate incorporates slots receiving a U-bolt for attachment to the vine stake.

4. The vine support system as defined in claim 1 wherein each shade hotel includes a boss extending from a bottom portion of a plate and further comprising crown rods extending from each vine stake, each crown rod carrying the shade hotel.

5. The vine support system as defined in claim 1 further comprising support wires suspended between the vine stakes and positioning shafts extending from the support wires.

6. The vine support system as defined in claim 2 wherein a portion of said plurality of shade hotels are removably mounted to a crown of the positioning shafts.

7. The vine support system as defined in claim 1 wherein the shade element comprises a woven shade cloth.

8. The vine support system as defined in claim 7 wherein the shade cloth contains a gradient in weaving density.

9. The vine support system as defined in claim 1 further comprising net sides depending from lateral edges of the shade element.

10. The vine support system as defined in claim 9 wherein the net sides are integral with the shade element.

11. The vine support system as defined in claim 10 wherein the net sides are removably attached to the shade element.

12. The vine support system as defined in claim 9 wherein the net sides incorporate vertical openings through which lateral ends of the shade hotel are received.

13. The vine support system as defined in claim 2 wherein the plate incorporates angled slots to receive lateral edges of the shade element.

14. The vine support system as defined in claim 2 wherein the plate incorporates a top flange, said shade element restrained between the top flange and bail.

15. A viticultural method for vine support comprising:
engaging shade hotels on a plurality of vine stakes positioned proximate an equal plurality of vine trunks; and,
supporting a shade element from the shade hotels.

16. The viticultural method as defined in claim 15 wherein the step of supporting a shade element comprises:
engaging a shade element between a top flange and a bail on the shade hotel.

17. The viticultural method as defined in claim 15 further comprising extending net sides downward from the shade element.

18. The viticultural method as defined in claim 15 further comprising:
mounting removable shade hotels at the top of positioning shafts and vine stakes.

19. The viticultural method as defined in claim 18 further comprising orienting the vine stakes at a desired angle for maximum shade by the shade element at a maximum solar exposure angle.

20. The viticultural method as defined in claim 18 wherein the shade element has gradient weaving density for asymmetrical enhanced shading by the shade element on one side.
